(19) United States
(12) Patent Application Publication
(10) Pub. No.: US 2024/0150660 A1
(43) Pub. Date: May 9, 2024

(54) HYDROCARBON PURIFICATION

(71) Applicant: LUTROS, LLC, Chattanooga, TN (US)

(72) Inventors: Mark MAUSS, Dubuque, IA (US); Travis DANNER, Chattanooga, TN (US)

(21) Appl. No.: 18/500,842

(22) Filed: Nov. 2, 2023

Related U.S. Application Data
(60) Provisional application No. 63/422,060, filed on Nov. 3, 2022.

(51) Int. Cl. C10G 29/02; B01D 17/04

(52) U.S. Cl. CPC C10G 29/02; B01D 17/045; C10G 2300/1014; C10G 2300/4006

(57) ABSTRACT

The present disclosure provides methods of purifying hydrocarbons. The methods include flowing an aqueous phase comprising water into a first end of a mixing region of a reactor along a first direction. An organic phase is mixed, via a countercurrent flow, with the aqueous phase by flowing the organic phase into a second end opposite to the first end of the mixing region. The organic phase comprises an oil, fat, grease, or combinations thereof, such as from vegetable and/or animal sources. The flow of the organic phase is along a second direction opposite to the first direction, and the organic phase comprises at least a contaminant comprising halides, phosphorous, sulfur, alkali metals, metalloids, heavy metals, or any combination thereof. The mixing region is heated. A purified organic phase is extracted from a purification region of the reactor. A waste is extracted from a waste region of the reactor.

### FIELD

Aspects of the present disclosure generally relate to systems and methods for purifying hydrocarbons, and more specifically, systems and methods for purifying oils and fats.

### BACKGROUND

Purification of hydrocarbons, e.g., fats, oils, and/or greases occurs for a variety of industries, e.g., food, cosmetics, waxes, biofuels, and other oleochemical products. Typically, hydrocarbons are purified using one or more steps to solubilize contaminants in an aqueous stream through the use of water washing, acid refining and/or caustic refining with centrifuges for separation. The contaminants are then further adsorbed and/or filtered out by using adsorbent filtrations, such as “bleaching clays,” silicas, diatomaceous earth and carbon black. Unfortunately, each of these processes are costly, where each subsequent process increases the capital and operating expenses along with waste disposal and product loss. Attempts to reduce waste disposal and product loss have implemented high shear mixing, cavitation, filtration powers, chelating agents, and enzymes. While these efforts have increased the efficiency and yield, the capital and operating expenses remained the same.

One process to reduce waste disposal and product loss includes the Colgate-Emery process. The Colgate-Emery process is a continuous-flow, countercurrent process that typically operates at 250-260° C. and 725 psig, where oil is fed into the bottom of a splitting tower and demineralized water is fed into the top of the tower. Unfortunately, the Colgate-Emery process liberates glycerin from glycerides and produces significant amounts of free fatty acids, both often undesirable in downstream refining. Also, the process must be operated below the glycerin decomposition temperature, e.g., 290° C. and requires long residence time, e.g., 2 to 3 hours, to permit gravity separation. Additionally, the Colgate-Emery process requires large equipment, making the process cost prohibitive for alternative fuel production due to the large volumes of oil that must be processed to be economically viable. Therefore, there is a need in the art for improved systems and methods for purifying hydrocarbons, especially methods for purifying oils and fats from vegetable and/or animal sources.

### SUMMARY

The present disclosure provides methods of purifying a hydrocarbon. The methods include flowing an aqueous phase into a first end of a mixing region of a reactor along a first direction. An organic phase is mixed, via a countercurrent flow, with the aqueous phase by flowing the organic phase into a second end opposite to the first end of the mixing region. The flow of the organic phase is along a second direction opposite to the first direction. The organic phase comprises at least a contaminant. The mixing region is heated. A purified organic phase is extracted from a purification region of the reactor. A waste is extracted from a waste region of the reactor.

The present disclosure also provides methods of purifying a hydrocarbon. The methods include flowing an aqueous phase into a first mixing region of a first reactor. An organic phase is mixed with the aqueous phase by flowing the organic phase into the first mixing region. A purified organic phase is separated from a waste. The purified organic phase is directed from the first reactor to a second mixing region of a second reactor.

The present disclosure also provides methods of purifying a hydrocarbon. The methods include flowing an aqueous phase comprising water into a first end of a mixing region of a reactor along a first direction. An organic phase is mixed, via a countercurrent flow, with the aqueous phase by flowing the organic phase into a second end opposite to the first end of the mixing region. The organic phase comprises an oil, fat, grease, or combination thereof. The flow of the organic phase is along a second direction opposite to the first direction, and the organic phase comprises at least a contaminant comprising halides, phosphorous, sulfur, alkali metals, metalloids, heavy metals, or any combination thereof. The mixing region is heated. A purified organic phase is extracted from a purification region of the reactor. A waste is extracted from a waste region of the reactor. The waste is directed to a recuperator.

### BRIEF DESCRIPTION OF THE DRAWINGS

So that the manner in which the above recited features of the present disclosure can be understood in detail, a more particular description of the disclosure, briefly summarized above, may be had by reference to aspects, some of which are illustrated in the appended drawings. It is to be noted, however, that the appended drawings illustrate only typical aspects of this present disclosure and are therefore not to be considered limiting of its scope, for the present disclosure may admit to other equally effective aspects.

FIGS. 1A and 1B are schematic views of a countercurrent liquid-liquid extraction column, according to an aspect of the disclosure. FIG. 1A is a schematic view of an extraction column. FIG. 1B is a schematic view of an extraction column having a packing material.

FIGS. 2A and 2B are schematic views of an agitated countercurrent liquid-liquid extraction column, according to an aspect of the disclosure. FIG. 2A is a schematic view of an agitated extraction column having a rotary mixer. FIG. 2B is a schematic view of an agitated extraction column having an oscillating mixer.

FIG. 3 is a schematic view of a countercurrent mixer-settler system, according to an aspect of the disclosure.

FIG. 4 is a schematic view of a countercurrent liquid-liquid extraction column having a recuperator, according to an aspect of the disclosure.

To facilitate understanding, identical reference numerals have been used, where possible, to designate identical elements that are common to the figures. The figures are not drawn to scale and may be simplified for clarity. It is contemplated that elements and features of one aspect may be beneficially incorporated in other aspects without further recitation.

### DETAILED DESCRIPTION

The descriptions of the various aspects of the present disclosure have been presented for purposes of illustration, but are not intended to be exhaustive or limited to the aspects disclosed. Many modifications and variations will be apparent to those of ordinary skill in the art without departing from the scope and spirit of the described aspects. The terminology used herein was chosen to best explain the principles of the aspects, the practical application or technical improvement over technologies found in the marketplace, or to enable others of ordinary skill in the art to understand the aspects disclosed herein.

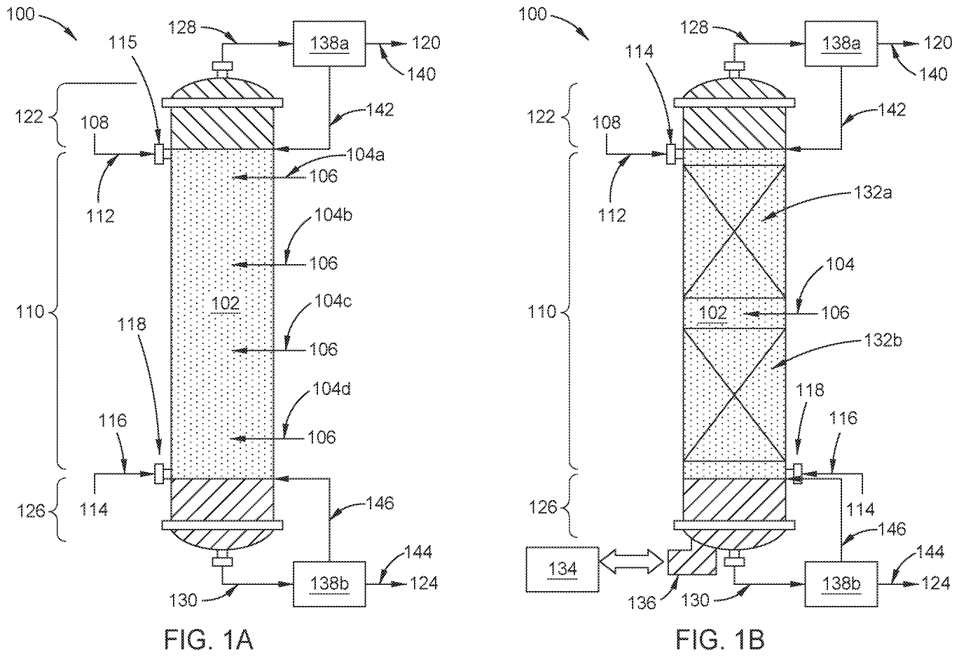

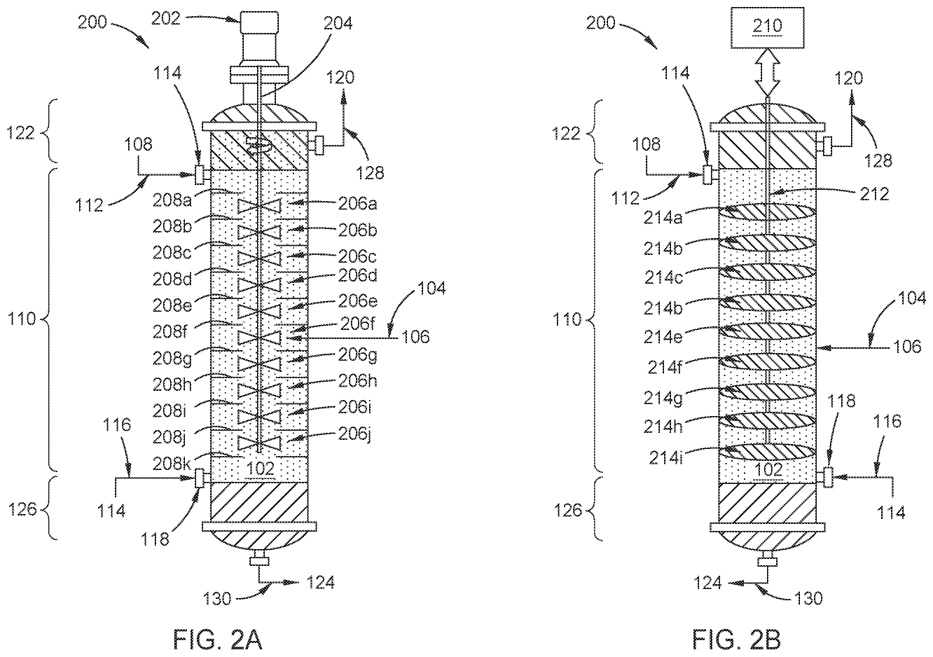

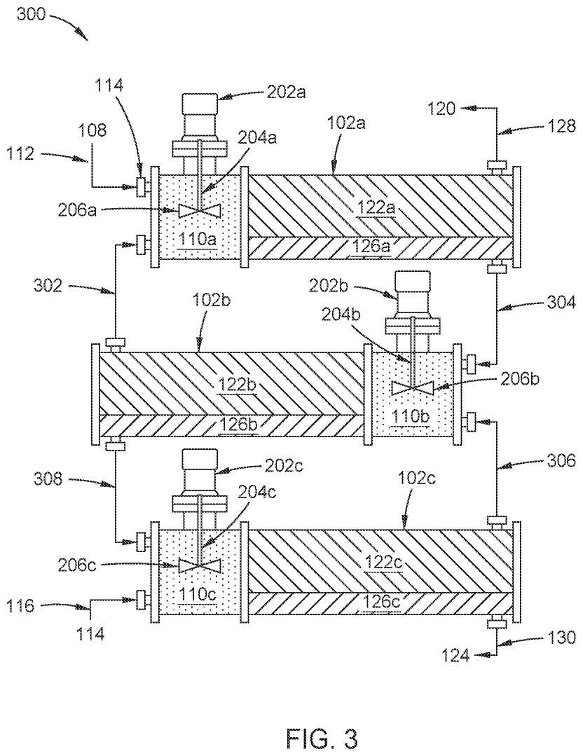

Aspects of the present disclosure generally relate to systems and methods for purifying hydrocarbons. In an embodiment, the systems and methods for purifying hydrocarbons includes a hydrocarbon purification system. In an embodiment, a hydrocarbon purification system can include a countercurrent liquid-liquid extraction column, as described below in detail, with reference to FIGS. 1A-3. Countercurrent liquid-liquid extraction columns can include fixed columns, as shown in FIGS. 1A, 1B, and 3, and agitated columns, as shown in FIGS. 2A and 2B. A fixed column may include no dynamic mechanisms, e.g., mixers, to induce turbulent fluid flow. A fixed column may facilitate contact between the organic phase and the aqueous phase using a fixed flow path that introduces the organic phase and an aqueous phase at opposite ends of a reactor. In an embodiment, a fixed column may include a packing material, e.g., structured packing or multiple sieve trays, which may improve contact between the aqueous phase and organic phase.

Now referring to FIG. 1A, a countercurrent liquid-liquid extraction column 100 is shown. The countercurrent liquid-liquid extraction column 100 includes a reactor 102. The reactor 102 includes a vessel, storage container, or column subsection configured to hold about 1 to about 20 times the flowrate of stream 114 of fluid, e.g., about 1 to about 5, about 5 to about 10, about 10 to about 15, or about 15 to about 20. In an embodiment, the reactor 102 can be a tubular plug-flow reactor (PFR), continuous stirred-tank reactor (CSTR), or any combination of these reactor types, such as PFR followed by CSTR, CSTR followed by PFR, or PFR followed by CSTR followed by PFR. Different reactor configurations provide a range of mixing, heat transfer, and residence time. In an embodiment, the reactor 102 may operate at a temperature of about 50° C. to about 500° C., e.g., about 50° C. to about 100° C., about 100° C. to about 150° C., about 150° C. to about 200° C., about 200° C. to about 250° C., or about 250° C. to about 300° C., about 300° C. to about 350° C., about 350° C. to about 400° C., about 400° C. to about 450° C., or about 450° C. to about 500° C. In at least an embodiment, the reactor 102 may include one or more heating devices, e.g., heat exchangers, to regulate the temperature of the reactor 102. The heating device may be internal and/or external to the reactor 102.

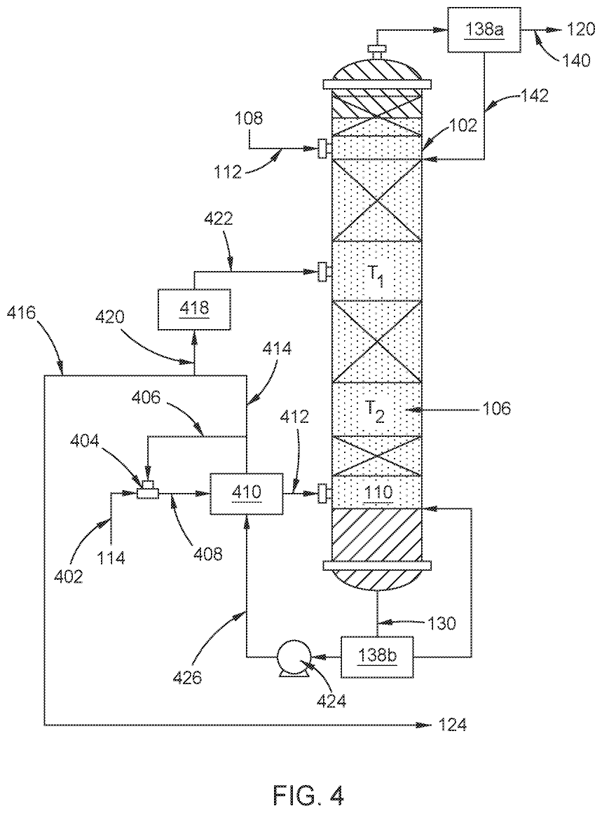

In an embodiment, the reactor 102 may be heated, cooled, or otherwise maintained at a constant temperature. For example, the reactor 102 may be maintained at a constant temperature of about 100° C. In an embodiment, the reactor 102 may have a temperature profile. A “temperature profile,” as used herein represents a range of temperatures that vary throughout the reactor 102. For example, a first region of the reactor 102 may operate at a first temperature of about 100° C. to about 125° C., while a second region of the reactor 102 may operate at a second temperature of about 200° C. to about 250° C., as described in further detail below, with reference to FIG. 4. Without being bound by theory, a temperature profile of the reactor 102 may enhance one or more of reactivity and/or solubility properties of a contaminant at different points in the reactor 102.

In an embodiment, the reactor 102 may operate at a pressure of about 50 pounds per square inch gauge (psig) to about 900 psig, e.g., about 50 psig to about 100 psig, about 100 psig to about 200 psig, about 200 psig to about 300 psig, about 300 psig to about 400 psig, about 400 psig to about 500 psig, about 500 psig to about 600 psig, about 600 psig to about 700 psig, about 700 psig to about 800 psig, or about 800 psig to about 900 psig. In an embodiment, the steam 106 may be introduced at a pressure sufficient to cause turbulent fluid flow, e.g., mixing, within the reactor 102. For example, the steam may be introduced at a fluid flow of about 150 barrels per day (bpd) to about 5,000 bpd, e.g., about 150 bpd to about 500 bpd, about 500 bpd to about 1000 bpd, about 500 bpd to about 1500 bpd, about 1000 bpd to about 1500 bpd, about 1500 bpd to about 2000 bpd, about 2000 bpd to about 3000 bpd, about 3000 bpd to about 4000 bpd, or about 4000 bpd to about 5000 bpd.

In an embodiment, a steam 106 may be introduced to the reactor 102, via lines 104a-104d. In an embodiment, the steam 106 may be introduced at a temperature of about 150° C. to about 270° C., e.g., about 150° C. to about 200° C., about 200° C. to about 250° C., or about 250° C. to about 270° C. Without being bound by theory, each of lines 104a-104d may independently introduce the steam 106 at varying temperatures. For example, the line 104a may introduce the steam 106 at a first temperature of about 100° C. to about 125° C., where the line 104b introduces the steam 106 at a second temperature of about 200° C. to about 250° C. In an embodiment, each of lines 104a-104d may independently introduce steam based on the temperature profile of the reactor 102.

The reactor 102 receives an aqueous phase 108 at a first end of a mixing region 110, via line 112, of the reactor. In an embodiment, the line 112 may include a diameter of about 20 mm to about 150 mm, e.g., about 20 mm to about 40 mm, about 40 mm to about 60 mm, about 60 mm to about 80 mm, about 80 mm to about 100 mm, about 100 mm to about 120 mm, or about 120 mm to about 150 mm. The aqueous phase 108 can include a polar solvent, e.g., water, alcohols, e.g., methanol, ethanol, propanol, or any combination thereof. For example, the aqueous phase 108 is water. As a further example, the aqueous phase 108 is or contains ethanol. The aqueous phase 108 may be introduced via line 112 using a distributer 115. In an embodiment, the distributer 115 may introduce 1 weight percent (wt %) to about 100 wt %, e.g., about 1 wt % to about 40 wt %, about 20 wt % to about 40 wt %, about 5 wt % to about 20 wt %, about 5 wt % to about 10 wt %, about 40 wt % to about 80 wt %, about 50 wt % to about 70 wt %, about 60 wt % to about 100 wt %, of the aqueous phase 108. In an embodiment, the distributer may produce droplets of the aqueous phase having a size or diameter of about 1 mm to about 15 mm, e.g., about 1 mm to about 5 mm, about 5 mm to about 10 mm, or about 10 mm to about 15 mm. Without being bound by theory, a droplet size of about 1 mm to about 15 mm of the aqueous phase may increase an overall capacity of the reactor 102 to purify one or more hydrocarbons.

The aqueous phase 108 may include about 50 parts per million (ppm) to about 20,000 ppm of one or more additives, e.g., about 50 ppm to about 1,000 ppm, about 1,000 ppm to about 4,000 ppm, about 4,000 ppm to about 6,000 ppm, about 6,000 ppm to about 8,000 ppm, about 8,000 ppm to about 10,000 ppm, or about 10,000 to about 20,000 ppm. In an embodiment, the one or more additives may be introduced to the aqueous phase 108 at line 112, line 142, line 124, line 130, mixing region 110, or a combination thereof. The additives may be or include a hydrolyzing agent, acid, base, salt, glycerin, chelating agent, polar solvent, non-polar solvent, or any combination thereof. For example, the additive may include one or more hydrolyzing agents. The hydrolyzing agent may be or include any chemical capable of hydrolyzing a hydrocarbon, e.g., fat, oil, or grease. For example, the hydrolyzing agent may be or include citric acid, sulfuric acid, phosphoric acid, salts thereof, or any combination thereof. As a further example, the hydrolyzing agent may be or include nitrilotriacetic acid (NTA), ethylenediaminetetraacetic acid (EDTA), sodium hydroxide, potassium hydroxide, lithium hydroxide, ammonium hydroxide, or any combination thereof. Without being bound by theory the additive may react with a triglyceride to separate a fatty acid of the triglyceride from the glycerin backbone, allowing for the purification of the fatty acids in the triglyceride. Additionally, and without being bound by theory, the additive may hydrolyze phospholipids and other contaminants more readily than fatty acids, allowing for selective hydrolyzing of phospholipids at lower temperatures and with shorter residence times than those required for fatty acid splitting of triglycerides, reducing free fatty acid formation in the reactor 102. Additionally, and without being bound by theory, the additive may increase a density and/or molecular weight of the aqueous phase 108, thereby promoting faster separation of the organic phase 114 and the aqueous phase 108.

The aqueous phase 108 may be introduced to the reactor 102 at a temperature of about 20° C. to about 200° C., e.g., about 20° C. to about 50° C., about 50° C. to about 100° C., about 100° C. to about 150° C., or about 150° C. to about 200° C. The aqueous phase 108 may be heated by a heating device (not shown), such as a heat exchanger to form a heated aqueous phase. The heating device may be internal and/or external to the aqueous phase 108 and/or the line 112. It should be appreciated that aqueous phase 108 can be heated by any known process or device and includes heat recovery from other processes described herein to optimize overall thermal efficiency. For example, the aqueous phase 108 may be heated by the steam 106 (not shown). In an embodiment, the aqueous phase 108 may be introduced to the reactor 102 at a pressure of about 25 psig to about 1000 psig, e.g., about 25 psig to about 100 psig, about 100 psig to about 200 psig, about 200 psig to about 300 psig, about 300 psig to about 400 psig, about 400 psig to about 500 psig, about 500 psig to about 600 psig, about 600 psig to about 700 psig, about 700 psig to about 800 psig, about 800 psig to about 900 psig, or about 900 psig to about 1000 psig.

The reactor 102 receives an organic phase 114 at a second end of the mixing region 110, via line 116, where the second end is opposite to the first end of the mixing region 110. The organic phase 114 flows from the second end towards the first end such that the organic phase 114 flows opposite the aqueous phase. As used herein, “opposite,” refers to a direction of flow of the organic phase in the mixing region 110 relative to the flow of the aqueous phase in the mixing region 110 of about 135° to about 225°, e.g., about 125° to about 150°, about 150° to about 175°, about 175° to about 185° (e.g., about 180°), about 175° to about 200°, or about 200° to about 225°. In an embodiment, the line 116 may include a diameter of about 20 mm to about 150 mm, e.g., about 20 mm to about 40 mm, about 40 mm to about 60 mm, about 60 mm to about 80 mm, about 80 mm to about 100 mm, about 100 mm to about 120 mm, or about 120 mm to about 150 mm.

The organic phase 114 may be introduced to the reactor 102 at a temperature of about 50° C. to about 250° C., e.g., about 50° C. to about 100° C., about 100° C. to about 150° C., about 150° C. to about 200° C., or about 200° C. to about 250° C. The organic phase 114 may be heated by a heating device (not shown), such as a heat exchanger to form a heated aqueous phase. The heating device may be internal and/or external to the organic phase 114 and/or the line 116. It should be appreciated that organic phase 114 can be heated by any known process or device and includes heat recovery from other processes described herein to optimize overall thermal efficiency. For example, the organic phase 114 may be heated by the steam 106 (not shown). In an embodiment, the organic phase 114 may be introduced to the reactor 102 at a pressure of about 25 psig to about 1000 psig, e.g., about 25 psig to about 100 psig, about 100 psig to about 200 psig, about 200 psig to about 300 psig, about 300 psig to about 400 psig, about 400 psig to about 500 psig, about 500 psig to about 600 psig, about 600 psig to about 700 psig, about 700 psig to about 800 psig, about 800 psig to about 900 psig, or about 900 psig to about 1000 psig.

The organic phase 114 can include a non-polar fluid, e.g., petroleum-based feedstocks, such as petroleum crude oil, shale oil, petroleum refinery intermediate streams (such as vacuum tower bottoms (VTB)), pyrolysis oils, recycled plastics, coal liquids, used motor oil, and mixtures thereof. Alternatively, the organic phase 114 may be a renewable feedstock, such as plant oil. Suitable plant oils include oils of canola, Carinata, castor, Jatropha, palm, Pongamia, soy bean, tung, and/or corn (such as derived from distiller grains), soap stock, waste vegetable oil, yellow grease (from cooking oil), brown grease (from grease traps and wastewater treatment), highly acidic oils (also referred to as acidic oils), animal tallow, algal oil, microbial oil, terpenes and other pine-related byproducts from tall oils, or other biosynthetic oils (such as derived from pyrolysis, esterification, oligomerization, or polymerization) and mixtures thereof. In an embodiment, the organic phase 114 may be plant based, animal based, insect based, microbial based, or any combination thereof.

The organic phase 114 may also include about 50 ppm to about 20,000 ppm of one or more additives, e.g., 50 ppm to about 1,000 ppm, about 1,000 g to about 4,000 ppm, about 4,000 ppm to about 6,000 ppm, about 6,000 g to about 8,000 ppm, about 8,000 ppm to about 10,000 ppm, or about 10,000 to about 20,000 ppm. In an embodiment, the one or more additives may be introduced to the organic phase 114 at line 116, line 1146, line 128, line 140, mixing region 110, or a combination thereof.

In at least an embodiment, the organic phase 114 includes about 1 parts per million (ppm) to about 5000 ppm, e.g., about 1 ppm to about 100 ppm, about 100 ppm to about 200 ppm, about 200 ppm to about 300 ppm, about 300 ppm to about 400 ppm, about 400 ppm to about 500 ppm, about 500 ppm to about 600 ppm, about 600 ppm to about 700 ppm, about 700 ppm to about 800 ppm, about 800 ppm to about 900 ppm, about 900 ppm to about 1000 ppm, about 1000 ppm to about 1100 ppm, about 1100 ppm to about 1200 ppm, about 1200 ppm to about 1300 ppm, about 1300 ppm to about 1400 ppm, about 1400 ppm to about 1500 ppm, about 1500 ppm to about 300 ppm, or about 3000 ppm to about 5000 ppm, of one or more contaminants, e.g., organic materials and/or inorganic materials. For example, inorganic materials may include halides (e.g., F, Cl, Br, I) such as chlorine containing compounds including chlorine, chlorides, chlorates, chlorites, chlorites, or any combination thereof, phosphorus and phosphorus-containing compounds and species, sulfur and sulfur-containing compounds and species, arsenic and arsenic-containing compounds and species, alkali metals and metalloids (e.g., B, Na, K, Si), heavy metals (Pb, Hg, Sb, Sn, Tl), and other metals (e.g., Ca, Fe, Mg, Ni, V, Zn, As, Al, Pb, Ba, Mn, Cr, Cu). As a further example, organic materials may include asphaltenes, polymers (such as polyesters and/or polypropylenes), high molecular weight organic compounds or waxes (such as containing greater than 50 carbon atoms, greater than 60 carbon atom, and/or having a boiling point greater than 600° C.), coke, coke precursors, nitrogen containing compounds (e.g., amines, amides, imines, enamines, nitrates, nitrites, proteins, amino acids, or any combination thereof), fatty acids, e.g., triglycerides, diglycerides, monoglycerides, or any combination thereof), organic salts, organic soaps, or any combination thereof.

The organic phase 114 may be introduced via line 116 using a distributer 118. In an embodiment, the distributer 118 may introduce 500 to about 50,000 bpd of organic phase, e.g., about 500 bpd to about 1,000 bpd, about 1,000 bpd to about 10,000 bpd, about 10,000 bpd to about 30,000 bpd, about 30,000 bpd to about 50,000 bpd. Without being bound by theory, the distributer 118 may disperse the flow of the organic phase 114 to provide uniform distribution throughout the mixing region 110. In an embodiment, the distributer may produce about 1 mm to about 15 mm droplets of the organic phase, e.g., about 1 mm to about 5 mm, about 5 mm to about 10 mm, or about 10 mm to about 15 mm. Without being bound by theory, a droplet size of about 1 mm to about 15 mm of the organic phase may increase an overall capacity of the reactor 102 to purify one or more hydrocarbons.

In an embodiment, the organic phase 114 and the aqueous phase 108 may be introduced to the mixing region 110 of the reactor 102 to provide a water-to-oil weight ratio of about 1:100 to about 3:1 in the mixing region 110, e.g., about 1:10 to about 1:1. In an embodiment, the organic phase 114 and the aqueous phase 108 may be introduced via countercurrent fluid flow to produce turbulent flow conditions. In an embodiment, the organic phase 114 may be introduced to the mixing region 110 such that the organic phase 114 is the continuous phase, e.g., greater than 50% volume of the mixing region, and the aqueous phase 108 is the dispersed phase, e.g., less than 50% volume of the mixing region 110. Without being bound by theory, a continuous phase that is the organic phase may provide for longer residence times for reactions, more time for the aqueous phase to separate from the organic phase, and more efficient heating in the mixing region. Alternatively, in an embodiment, the organic phase 114 may be introduced to the mixing region such that the organic phase 114 is the dispersed phase, e.g., less than 50% volume of the mixing region 110, and the aqueous phase 108 is the continuous phase, e.g., greater than 50% volume of the mixing region 110. Without being bound by theory, a continuous phase that is the aqueous phase may provide for faster separation of the organic phase and the aqueous phase and/or a reduced residence time as compared to when the continuous phase is the aqueous phase.

For example, turbulent flow conditions may include turbulent flow exhibiting a Reynolds Number (Re) of about 1000 to about 5000, e.g., about 1000 Re to about 2000 Re, about 2000 Re to about 3000 Re, about 3000 Re to about 4000 Re, or about 4000 Re to about 5000 Re. Without being bound by theory, a countercurrent fluid flow to produce turbulent flow conditions can optimize mixing and maximize heat transfer between the aqueous phase and the organic phase.

In an embodiment, the organic phase 114 and the aqueous phase 108 may be mixed in the mixing region 110, where purified hydrocarbon 120 may rise to a purification region 122 of the reactor 102. Purified hydrocarbon 120 may be or include clean oil that has about 90% to about 100% of contaminants removed from the oil as compared to the organic phase 114, e.g., about 90% to about 92%, about 92% to about 94%, about 94% to about 96%, about 96% to about 98%, or about 98% to about 100% contaminants removed from the oil. For example, the purified hydrocarbon 120 may include a reduction of about 95% of contaminants of oil compared to the organic phase 114, e.g., phosphorus, salts, minerals, and/or metal content. As a further example, the organic phase 114 may include about 100 ppm to about 2000 ppm of phosphorous and the purified hydrocarbon 120 may include about 1 ppm to about 50 ppm of phosphorous, e.g., 1 ppm to about 10 ppm, about 10 ppm to about 20 ppm, about 20 ppm to about 30 ppm, about 30 ppm to about 40 ppm, or about 40 ppm to about 50 ppm. In an embodiment, the purified hydrocarbon 120 may include less than 0.2% carbon residue, less than 0.1% asphaltene, less than 0.05% ash, and/or less than 20 ppm metals total. In another embodiment, the purified hydrocarbon 120 may include less than 0.1 ppm to about 3000 ppm nitrogen, less than 0.1 ppm to about 1000 ppm chlorine, less than 0.1 ppm to about 1500 ppm calcium, less than 0.1 ppm to about 800 ppm iron, less than 0.1 ppm to about 600 ppm potassium, and less than 0.1 ppm to about 800 ppm sodium.

In an embodiment, the organic phase 114 and the aqueous phase 108 may be mix in the mixing zone, where waste 124 may fall or otherwise be introduced to a waste region 126. The waste 124 may include the aqueous phase 108 having the contaminants from the organic phase 114. In an embodiment, the waste 124 may include about 50 ppm to about 30,000 ppm of phosphorous, salts, metal content, and/or minerals, e.g., about 50 ppm to about 500 ppm, about 500 ppm to about 1000 ppm, about 1000 ppm to about 10.000 ppm, or about 10,000 ppm to about 30,000 ppm. In an embodiment, the waste 124 may be free of or substantially free of the organic phase 114. For example, the waste 124 may include about 0.01% v/v to about 1% v/v of the organic phase 114, e.g., about 0.01% v/v to about 0.05% v/v, about 0.05% v/v to about 0.1% v/v, about 0.1% v/v to about 0.5% v/v, about 0.5% v/v to about 1% v/v.

In an embodiment, purified hydrocarbon 120 and the waste 124 may separate in the mixing region 110 based on density. For example, purified hydrocarbon may have a density of less than 1 g/cm³, e.g., less than 0.9 g/cm³, less than 0.8 g/cm³, less than 0.7 g/cm³, less than 0.6 g/cm³, or less than 0.5 g/cm³, while waste 124 may have a density of about 0.5 g/cm³ or greater, e.g., about 0.5 g/cm³, about 1 g/cm³, about 1.1 g/cm³, about 1.2 g/cm³, about 1.3 g/cm³, about 1.4 g/cm³, or about 1.5 g/cm³, in which the waste density is greater than the purified hydrocarbon density. In an embodiment, the purified hydrocarbon 120 may rise above the waste 124 due to gravity and the waste 124 being denser than the purified hydrocarbon 120. Additionally, the rate at which the aqueous phase 108 and the organic phase 114 separates may vary based on a droplet size (e.g., about 100 microns to about 20 mm, e.g., about 100 microns to about 1 mm, about 1 mm to about 10 mm, or about 10 mm to about 20 mm), agitation (e.g., pulsation, rotation, or oscillation (such as frequency, amplitude, rpm)), coalescing media (random packing, structured packing, coalescing elements, hydrophilic nature, hydrophobic nature, dispersed phase, or continuous phase), temperature (e.g. about 100° C. to about 200° C., such as about 100° C. to about 150° C. or about 150° C. to about 200° C.), density (e.g., a greater density difference may promote faster separation), and viscosity (e.g., about 0.1 centipoise (cP) to about 1.8 cP (such as about 0.1 cP to about 0.5 cP, about 0.5 cP to about 1 cP, or about 1 cP to about 1.8 cP) for the aqueous phase and about 5 cP to about 1,000 cP (such as about 5 cP to about 100 cP, about 100 cP to about 500 cP, or about 500 cP to about 1,000 cP cP) for the organic phase. 0.5-100 cP) of each the organic and aqueous phase 108.

The purified hydrocarbon 120 may be extracted via line 128. In an embodiment, a filter (not shown) may be placed on line 128. The filter (not shown) may remove or prevent contaminants that may remain in the purified oil 120 from being directed for further processing, as described below. In an embodiment, the filter (not shown) may include a ceramic cross-membrane filter.

The purified hydrocarbon 120 may be extracted at a temp of about 200° C. to about 300° C., e.g., about 200° C. to about 220° C., about 220° C. to about 240° C., about 240° C. to about 260° C., about 260° C. to about 280° C., or about 280° C. to about 300° C. The purified hydrocarbon 120 may be directed to a first coalescer 138a. The first coalescer 138a may include a mechanical coalescer and/or an electrostatic coalescer suitable to separate the residual aqueous phase 114 from the purified oil 120, if any. The purified oil 120 may exit the first coalescer 138a, via line 140, and may be further processed (not shown) into chemicals or fuels depending on the type of purified hydrocarbon and the product objectives. Renewable and petroleum oils may be hydrothermally cracked into synthetic crude via a high-rate reactor system and then hydrotreated into transportation fuels or chemicals. Alternatively, renewable oil may be converted into biodiesel via esterification or hydrotreatment, hydroisomerization, and hydrocracking into renewable fuels and chemicals via conventional refining processes.

In at least an embodiment, the residual aqueous phase 114 that is recovered by the first coalescer 138a may be directed to the mixing region 110 of the reactor 102, via line 142. Alternatively, the residual aqueous phase 114 that is recovered by the first coalescer 138a may be directed to the purification region 122 and/or the waste region 126 of the reactor 102.

The waste 124 may be extracted via line 130. In an embodiment, a filter (not shown) may be placed on the line 130. In an embodiment, the filer (not shown) may be placed in any of line 426 and/or 416, with reference to FIG. 4. The filter (not shown) may remove or prevent contaminants that may remain in the waste 124 from being directed for further processing, as described below. In an embodiment, the filter (not shown) may include a ceramic cross-membrane filter.

The waste 124 may be extracted at a temp of may be extracted at a temp of about 200° C. to about 300° C., e.g., about 200° C. to about 220° C., about 220° C. to about 240° C., about 240° C. to about 260° C., about 260° C. to about 280° C., or about 280° C. to about 300° C. The waste 124 may be directed to a second coalesce 138b. The second coalescer 138b may include a mechanical coalescer and/or an electrostatic coalescer suitable to separate the residual organic phase 108 from the waste 124, if any. The waste 124 may exit the second coalesce 138b, via line 144, and may be further treated, reused, or processed to recover byproducts, apply to land, or recycle. The waste 124 may be processed to remove one or more salts from the waste 124 that were extracted from the organic phase 114, such that the waste 124 may be recycled as the aqueous phase 108, as described below in detail, with reference to FIG. 4. In an embodiment, the countercurrent liquid-liquid extraction column 100 depicted in FIG. 1A and FIG. 1B may be used for rapid hydrolysis, where pure glycerin may be extracted in the waste 124 and recovered by conventional distillation processes. In an embodiment, the waste 124 may include water and an additive ion, e.g., phosphate ion and/or citrate ion, which may be recovered and reused as a nutrient source for growing crops or algae.

In at least an embodiment, the residual organic phase 108 that is recovered by the second coalesce 138b may be directed to the mixing region 110 of the reactor 102, via line 146. Alternatively, the residual organic phase 108 that is recovered by the second coalesce 138b may be directed to the purification region 122 and/or the waste region 126 of the reactor 102.

In an embodiment, a coalesce, e.g., mechanical coalesce and/or electrostatic coalescer could be located in the reactor 102, e.g., in the purification region 122, the mixing region 110, and/or the waste region 126. While only two coalescers are shown in FIG. 1A, any number of coalescers may be implemented, e.g., 1, 2, 3, 4, 5, 6, 7, 8, 9, 10, or more coalescers.

Now referring to FIG. 1B, a schematic view of an extraction column 100 having a packing material 132 is shown. The packing material 132 can include a structured packing material or multiple sieve trays. For example, the packing material 132 can include a polymeric material, a ceramic material, a metallic material, and/or a glass material. In an embodiment, one or more packing materials 132a-132b can be disposed within the extraction column 100. For example, a first packing material 132a can be disposed in the mixing region 110 of the reactor, proximal to the purification region 122, where a second packing material 132b can be disposed in the mixing region 110 of the reactor, proximal to the waste region 126. While only two packing materials 132a-132b are shown, any number of packing materials may be placed in the mixing region 110 of the reactor. For example, there may be 1, 2, 3, 4, 5 or more packing materials placed in the mixing region 110 of the reactor. Without being bound by theory the packing material 132 may be disposed in the mixing region 110 based on one or more of a void fraction, surface area, unit volume, random packing arrangement, structure packing arrangement, tray, continuous phase, dispersed phase, viscosity, and/or surface tension.

The packing materials may restrict one or more flows of the aqueous phase 108 and/or the organic phase 114, where the upward flow of the organic phase 114 may not exceed the rate at which the aqueous phase 108 descends the extraction column 100. Additionally, the rate at which the aqueous phase 108 descends the extraction column 100 may vary based on a droplet size, agitation, coalescing media, temperature, density, and viscosity of the aqueous phase 108. Without being bound by theory, by restricting flow of the aqueous phase 108 and/or the organic phase 114 additional mixing during the countercurrent flow may occur, increasing the amount of contaminants that are removed from the organic phase 114.

In an embodiment, the extraction column 100 may include a pump 134. The pump 134 may include any pump capable of generating a pulsation to the extraction column 100 via line 136. While only one pump 134 is shown, any number of pumps 134, e.g., 1, 2, 3, 4, 5, 6, 7, 8, 9, 10, or more pumps, may be incorporated to provide sufficient pulsation to the waste region 126, mixing region 110, and/or purification region 122. Without being bound by theory, pulsation can provide better agitation and interaction between the aqueous phase 108 and the organic phase 114 during the countercurrent flow through the reactor 102, as compared to conventional co-current flow through a reactor 102.

Now referring to FIG. 2A, a schematic view of an agitated extraction column 200 is shown. The agitated extraction column 200 may include any of the extraction column 100, as described above in detail, with reference to FIGS. 1A and 1B. The agitated extraction column 200 can include an actuator 202. The actuator 202 can include any component suitable to produce a force, torque, or displacement of another component in the agitated extraction column 200. For example, the actuator 202 can include an electrical actuator, pneumatic actuator, hydraulic actuator, or servomotor. In an embodiment, the actuator 202 actuates a drive shaft 204. A drive shaft 204 can include a metal, wood, ceramic, glass or polymer. For example, the drive shaft 204 can include a metal rod, e.g., titanium or stainless steel. Without being bound by theory, the drive shaft 204 may agitate or mix the fluids in the mixing region 110, without oxidizing or reacting with the aqueous phase 108 and/or organic phase 114.

The drive shaft 204 may extend from a first side of the reactor 102 towards a second side of the reactor 102. The drive shaft 204 may rotate about an axis, e.g., a longitudinal axis. In an embodiment, the drive shaft 204 may rotate about the longitudinal axis, in which a plurality of displacement components 206a-j may agitate the aqueous phase 108 and organic phase 114 flowing countercurrent through the mixing region 110. Each displacement component of the plurality of displacement components 206a-206j may be any suitable device suitable for displacing a fluid in the mixing region 110. For example, each displacement component of the plurality of displacement components 206a-206j may independently be or include an impeller, a paddle, a propeller, an agitator, a spinner, a blade, or any combination thereof. In an embodiment, each displacement component of the plurality of displacement components 206a-206j may independently be or include a metal, wood, ceramic, glass or polymer. For example, each displacement component of the plurality of displacement components 206a-206j can include a metal rod, e.g., titanium or stainless steel. While 10 displacement components 206a-206j are shown, any number of displacement components may be implemented in the agitated extraction column 200, e.g., 1, 2, 3, 4, 5, 6, 7, 8, 9, 10, or more displacement components.

The drive shaft 204 may be configured to rotate the plurality of displacement components 206a-206j at a speed of about 5 RPM to about 1200 RPM, e.g., about 5 RPM to about 100 RPM, about 100 RPM to about 500 RPM, about 500 RPM to about 1000 RPM, or about 1000 RPM to about 1200 RPM. Without being bound by theory, rotating the plurality of displacement components 206a-206j at a speed of about 30 RPM to about 300 RPM may enhance the interaction between the aqueous phase 108 and the organic phase 114, while concurrently allowing for separation to the waste region 126 and the purification region 122.

In an embodiment, the reactor 102 may include a plurality of baffles 208a-208k disposed on a wall of the reactor 102. Each baffle of the plurality of baffles 208a-208k may separate each displacement component of the plurality of displacement components 206a-206j. Without being bound by theory by separating each displacement component of the plurality of displacement components 206a-206j with each baffle of the plurality of baffles 208a-208k, an improved mass transfer between the aqueous phase 108 and the organic phase 114 may occur due to the increased agitation in the mixing region 110.

Now referring to FIG. 2B, a schematic view of an agitated extraction column 200 is shown. The agitated extraction column 200 may include any of the extraction column 100, as described above in detail, with reference to FIGS. 1A and 1B. The agitated extraction column 200 can include an oscillator 210. The oscillator 210 can include any component suitable to oscillate another component in the agitated extraction column 200. In an embodiment, the oscillator may be coupled to a central shaft 212, where the oscillator 210 may oscillate the central shaft longitudinally. A central shaft 212 can include one or more types of materials, such as metal, wood, ceramic, glass polymeric, or any combination thereof. For example, the central shaft 212 can include a metal rod, e.g., titanium or stainless steel. Without being bound by theory, the central shaft 212 may oscillate in the mixing region 110 based on the oscillator 210, without oxidizing or reacting with the aqueous phase 108 and/or organic phase 114. The central shaft 212 may extend from a first side of the reactor 102 towards a second side of the reactor 102.

In an embodiment, a plurality of perforated components 214a-214i. Each perforated component of the plurality of perforated components 214a-214i may include a metal, wood, ceramic, glass or polymer. For example, each perforated component of the plurality of perforated components 214a-214i may independently be or include a ceramic perforated component and/or a metal perforated component. While only 9 perforated components 214a-214i are shown, any number of perforated components may be implemented in the agitated extraction column 200, e.g., 1, 10, 20, 30, 40, 50, 60, 70, 80, 90, 100, or more perforated components.

In an embodiment, each perforated plate of the plurality of perforated plates may include an average pore size of about 3 mm to about 50 mm, e.g., about 3 mm to about 10 mm, about 10 mm to about 20 mm, about 20 mm to about 30 mm, about 30 mm to about 40 mm, or about 40 mm to about 50 mm. Without being bound by theory, a smaller pore size may increase agitation in the mixing region 110, enhancing the interaction between the aqueous phase 108 and the organic phase 114.

In an embodiment, the plurality of perforated components 214a-214i may oscillate longitudinally based on the oscillator 210 at a frequency of about 0.5 hz to about 60 hz, e.g., about 0.5 hz to about 5 hz, about 5 hz to about 20 hz, about 20 hz to about 40 hz, or about 40 hz to about 60 hz. In an embodiment, the plurality of perforated components 214a-214i may oscillate longitudinally based on the oscillator 210 at a distance of about 10 mm to about 150 mm, e.g., about 10 mm to about 50 mm, about 50 mm to about 100 mm, or about 100 mm to about 150 mm. Without being bound by theory, an oscillator 210 that oscillates the plurality of perforated components 214a-214i at a greater frequency and/or distance may enhance the interaction between the aqueous phase 108 and the organic phase 114, while concurrently allowing for separation to the waste region 126 and the purification region 122.

Now referring to FIG. 3, a schematic view of a countercurrent mixer-settler system 300 is shown. The countercurrent mixer-settler system 300 can include a first reactor 102a. The first reactor 102a can include any of the reactor 102, as described above, with reference to FIGS. 1A and 1B. In an embodiment, the first reactor 102a receives an aqueous phase 108 from a distributer 115, via line 112. The aqueous phase 108 enters a first mixing region 110a of the first reactor 102a. The first mixing region 110a can include a first actuator 202a, a first drive shaft 204a, and a first displacement component 206a. An organic phase 114 enters the first mixing region 110a via line 302. The aqueous phase 108 and the organic phase 114 exit the first mixing region 110a and separate based on gravity, droplet size, agitation, coalescing media, temperature, density, and viscosity, as described above to form a first purification region 122a and a first waste region 126a.

A purified hydrocarbon 120 is extracted from the first purification region 122a, while the waste 124 in the first waste region 126a flows through the line 304 to a second reactor 102b. The second reactor 102b can include any of the reactor 102, as described above, with reference to FIGS. 1A and 1B. In an embodiment, the second reactor 102b receives an aqueous phase 108 from the first waste region 126a, via line 304. The aqueous phase 108 enters a second mixing region 110b of the second reactor 102b. The second mixing region 110b can include a second actuator 202b, a second drive shaft 204b, and a second displacement component 206b. An organic phase 114 enters the second mixing region 110b, via line 306. The aqueous phase 108 and the organic phase 114 exit the second mixing region 110b and separate based on gravity, droplet size, agitation, coalescing media, temperature, density, and viscosity, as described above to form a second purification region 122b and a second waste region 126b. Purified hydrocarbon from the second purification region 122b may be directed to the first mixing region 110a, via line 302.

In an embodiment, the waste 124 of the second waste region 126b may be directed to a third mixing region 110c, via line 308, of a third reactor 102c. The third reactor 102c can include any of the reactor 102, as described above, with reference to FIGS. 1A and 1B. In an embodiment, the third reactor 102c receives an aqueous phase 108 from the second waste region 126b, via line 308. The third mixing region 110c can include a third actuator 202c, a third drive shaft 204c, and a third displacement component 206c. An organic phase 114 enters the third mixing region 110c, via line 116. The aqueous phase 108 and the organic phase 114 exit the third mixing region 110c and separate based on gravity, droplet size, agitation, coalescing media, temperature, density, and viscosity, as described above to form a third purification region 122c and a third waste region 126c. Purified hydrocarbon from the third purification region 122c may be directed to the second mixing region 110b, via line 306. The waste 124 of the third waste region 126c may be extracted from the countercurrent mixer-settler system 300 via line 130.

While only three reactors 102a, 102b, and 102c are shown, the countercurrent mixer-settler system 300 can include any number of reactors suitable to purify one or more organic phases, e.g., 2 reactors, 3 reactors, 4 reactors, 5 reactors, 6 reactors, 7 reactors, 8 reactors, 9 reactors, 10 reactors, or more than 10 reactors. Without being bound by theory, organic phases that flow through each reactor of the plurality of reactors become progressively more purified, where the purified hydrocarbon exits at the first reactor 102a of the plurality of reactors, and the waste 124 exits at the last reactor of the plurality of reactors.

In at least an embodiment, the reactors 102a, 102b, and 102 may include one or more heating devices, e.g., integrated coils, recuperative heat exchangers, and/or primary heat exchangers, to regulate the temperature of the reactor 102. The heating device may be internal and/or external to the reactor 102. Additionally, in at least an embodiment, each of the reactors 102a, 102b, and 102c may independently include one or more direct steam injections (not shown). Without being bound by theory, temperatures of the organic phase 114 and the aqueous phase 108 may be regulated to promote heat transfer between each successive mixing region, such that each of the organic phase 114 and the aqueous phase 108 act as a heat exchanger in the mixing regions. Additionally, and without being bound by theory, each mixing region may independently be operated at a different temperature of about 50° C. to about 300° C. to promote purification of one or more hydrocarbons, e.g., oil, fats, grease, or any combination thereof.

Now referring to FIG. 4, a schematic view of a countercurrent liquid-liquid extraction column 400 is shown. The countercurrent liquid-liquid extraction column 400 includes a reactor 102, the reactor 102 includes any of the reactor 102, as described above in detail, with reference to FIGS. 1A and 1B. In an embodiment, the reactor 102 includes a temperature profile, in which the temperature profile includes a first temperature “T₁” and a second temperature “T₂”. In an embodiment, each of T₁ and T₂ may independently be about 50° C. to about 300° C., e.g., about 50° C. to about 100° C., about 100° C. to about 150° C., about 150° C. to about 200° C., about 200° C. to about 250° C., or about 250° C. to about 300° C. In an embodiment, T₁ may be greater than T₂. In an embodiment, T₂ may be greater than T₁. Without being bound by theory, where T₂ is greater than T₁, an increase of hydrocarbon purification may occur.

In an embodiment, the temperature profile, including T₁ and T₂, may be established using an external heater (not shown). A portion of the volume in the mixing region 110 may be extracted from a first region of the mixing region 110, e.g., T₁ or T₂. The portion may be directed to a heat exchanger (not shown) that is external to the reactor 102. The heat exchanger (not shown) may heat the portion of the volume received from the mixing region and reintroduce the heated portion of the volume to a second region of the mixing region 110, e.g., e.g., T₁ or T₂. For example, the temperature profile may be established by extracting a portion of the volume in the mixing region 110 from a first region such as T₂, heating the portion using the external heat exchanger (not shown), and directing the heated portion to a second region of the mixing region 110. Without being bound by theory, the temperature profile may assist in reducing the pressure of the reactor 102 and may lower the overall temperature of the reactor to prevent impurities or coking out of impurities.

In an embodiment, the portion of the volume in the mixing region 110 may be extracted from a first region of the mixing region 110 and directed to an external vessel, e.g., storage vessel, transport line, tank, holder, valve, or a combination thereof. The external vessel may be heated by the heat exchanger (not shown) that is external to the reactor 102. The external vessel may retain the portion of the volume such that there is a residence time of about 1 second to about 30 days, e.g., about 1 second to about 60 seconds, about 60 seconds to about 1 hour, about 1 hour to about 24 hours, about 24 hours to about 7 days, or about 7 days to about 30 days. The external vessel may transfer the portion of the volume to the mixing region 110, in which transferring the portion of the volume of the mixing region 110 may include cooling the portion of the volume. For example, the portion of the volume of the mixing region 110 may be cooled using a cooling system, e.g., water cooler, a chiller, a refrigeration system, or the like. In an embodiment, the cooling system may cool the portion of the volume to a temperature of about 5° C. to about 250° C., e.g., about 5° C. to about 20° C., about 20° C. to about 50° C., about 50° C. to about 100° C., about 100° C. to about 150° C., about 150° C. to about 200° C., or about 200° C. to about 250° C. Without being bound by theory, by cooling the portion of the volume of the mixing region in the external vessel before re-introducing to the mixing region 110, the pressure and/or temperature of the reactor 102 may be lowered, preventing impurities from forming or coking out of impurities in the reactor 102.

In an embodiment, an aqueous phase 108 is introduced to a mixing region 110 of the reactor 102, via line 112. In an embodiment, the line 112 may include a diameter of about 20 mm to about 150 mm, e.g., about 20 mm to about 40 mm, about 40 mm to about 60 mm, about 60 mm to about 80 mm, about 80 mm to about 100 mm, about 100 mm to about 120 mm, or about 120 mm to about 150 mm. In an embodiment, the aqueous phase 108 may be introduced to the mixing region 110 of the reactor using one or more pumps (not shown). The aqueous phase 108 may be introduced to the mixing region 110 at a temperature of about 20° C. to about 80° C., e.g., about 20° C. to about 40° C., about 40° C. to about 60° C., or about 60° C. to about 80° C.

Concurrently, an organic phase 114 may be introduced to the countercurrent liquid-liquid extraction column 400, via line 402, at a temperature of about 80° C. to about 100° C. using one or more pumps (not shown), e.g., about 80° C. to about 90° C., about 90° C. to about 95° C., or about 95° C. to about 100° C. Without being bound by theory, by heating the organic phase prior to contact with the aqueous phase, a reduction in the loss of phospholipids from the organic phase may occur. Line 402 may direct the organic phase 114 through a valve 404. The valve 404 may include a T-valve. The T-valve may direct a portion of the waste 124, via line 406, that exits the reactor 102 to the organic phase 114, to the organic phase 114. In an embodiment, a temperature of the portion of the waste in the line 406 may be about 80° C. to about 100° C., e.g., about 80° C. to about 90° C., about 90° C. to about 95° C., or about 95° C. to about 100° C. In an embodiment, the T-valve 404 may produce a mixture by introducing the waste 124 such that the line 408 includes about 70% v/v to about 90% v/v of the organic phase 114 and about 10% v/v to about 30% v/v of the waste 124.

In an embodiment, line 408 may direct the organic phase 114 to a recuperator 410. Additionally, the waste 124 may exit the reactor 102 via the waste region 126 and be directed to a compressor 424, via line 130. In an embodiment, the line 130 may include one or more filters and/or filtration systems, as described above in detail. For example, the line 130 may include a micro-cross-flow filtration system. Without being bound by theory, the line 130 having a filter and/or filtration system may purify the waste 124 such that the waste 124 may be recycled to the reactor 102 as a purified aqueous phase. The compressor 424 may compress the waste 124 to a pressure of about 10 psi to about 50 psi above the pressure of the reactor 102, e.g., about 10 psi to about 20 psi, about 20 psi to about 30 psi, about 30 psi to about 40 psi, or about 40 psi to about 50 psi. The compressed waste may be directed to the recuperator 410, via line 426.

In an embodiment, the recuperator 410 may receive the compressed waste, via line 426, and the organic phase 114, via line 408, where the recuperator 410 directs the fluid using one or more re valves and/or gates capable of directing and/or diverting fluid. In an embodiment, the recuperator 410 may direct the organic phase 114 and/or the mixture of organic phase and waste to the mixing region 110 via line 412. Alternatively, or concurrently, the recuperator 410 may direct the waste and/or mixture of organic phase and waste to the line 414, which may exit the countercurrent liquid-liquid extraction column 400 via line 416 and/or be directed to a cooling unit 418, via line 420. Without being bound by theory, the recuperator 410 may cause a reduction in the loss of phospholipids may occur as the entering oil is preheated by the waste 124 that just exited the reactor 102.

In an embodiment, the cooling unit 418 may cool the organic phase 114 and/or the mixture of the organic phase 114 and the waste 124 to a temperature of about 70° C. to about 90° C., e.g., about 70° C. to about 80° C., about 80° C. to about 85° C., or about 85° C. to about 90° C. The cooled organic phase 114 and/or mixture may be introduced to the mixing region 110 via line 422.

Without being bound by theory, a reduction in the overall net water usage for countercurrent fluid flow can occur due to the recuperator 410 and the cooling unit 418. By recycling the waste 124 using the recuperator, the aqueous phase 108 may be reused and recycled to extract the impurities from the organic phase 114 numerous times prior to be removed from the countercurrent liquid-liquid extraction column 400. Additionally, the waste 124 exiting the waste region 126 of the reactor 102 may have elevated temperatures of about 100° C. to about 300° C., which may provide effective heat transfer to the organic phase 114 prior to entering the mixing region 110 of the reactor 102. Accordingly, a reduction of about 5% to about 50% of the aqueous phase 108, introduced via line 112, may occur. For example, about 1% to about 40% of the aqueous volume in the mixing region 110 may originate as the aqueous phase 108, via line 112, whereas about 60% to about 99% of the aqueous volume in the mixing region 110 may originate from the recuperator 410 via line 412 and/or line 422.

In an embodiment, the each of lines 112, 402, 406, 408, 412, 414, 416, 420, 422, and 426 may independently include a diameter of about 20 mm to about 150 mm, e.g., about 20 mm to about 40 mm, about 40 mm to about 60 mm, about 60 mm to about 80 mm, about 80 mm to about 100 mm, about 100 mm to about 120 mm, or about 120 mm to about 150 mm.

### Examples

Trials were conducted in a 1-liter stainless-steel Parr reactor including a magnetically coupled agitator. The reactor was externally heated by electric heating coils. The reactor was instrumented with a thermocouple and 500 psig pressure transducer that was monitored by an Allen Bradley CompactLogix™ programmable logic controller, which was also used to control the heating coils. The reactor was vented at the beginning of each trial, and filled with steam prior to closing the vent.

Trials were conducted at various temperatures and durations, as shown below in Table 1. Each trial included a crude degummed organic soybean oil, distilled water, and about 1000 ppm citric acid. The crude degummed soybean oil had a starting free fatty acid of 1.3 wt % and 1329 ppm phosphorus. The “Liq Water” column in the table was an estimate of the water content of the reaction mixture taking into account water vapor filling the headspace of the reactor.

TABLE 1

| | | | Peak | Peak | Res | | | Citric | | |
|---|---|---|---|---|---|---|---|---|---|---|
| | Phos. | Final | Temp | Press | Time | Oil | Water | 50% | Liq | Citric |
| Trial | (ppm) | FFA | (° C.) | (psig) | (min) | (g) | (g) | (g) | Water | 100% |
| 1 | 25.5 | 2.4% | 215 | 291 | 3 | 173.9 | 115.3 | 0.36 | 58% | 0.10 |
| 2 | 5.7 | 2.9% | 220.6 | 326 | 11 | 174.9 | 115.9 | 0.31 | 56% | 0.09 |
| 3 | 5.1 | 10.1% | 221.1 | 329 | 41 | 175.0 | 116.0 | 0.32 | 56% | 0.09 |
| 4 | 5.5 | 9.6% | 204.4 | 232 | 72 | 175.5 | 115.2 | 0.31 | 58% | 0.09 |
| 5.1 | 93.3 | 1.7% | 164.4 | 85 | 32 | 176.3 | 176.3 | 0.32 | 97% | 0.09 |
| 5.2 | 5.5 | 12.2% | 202.2 | 221 | 75 | 168.0 | 174.0 | 0.33 | 96% | 0.10 |
| 6 | 7.4 | 10.6% | 186.1 | 152 | 148 | 177.8 | 175.4 | 0.33 | 94% | 0.09 |
| 7.1 | 9 | 4.5% | 186.1 | 152 | 73 | 175.0 | 116.0 | 0.34 | 61% | 0.10 |
| 7.2 | 10 | 7.5% | 185.6 | 150 | 69 | 165.0 | 118.0 | 0.33 | 66% | 0.10 |
| 8 | 9.5 | 7.4% | 170.6 | 101 | 254 | 178.2 | 178.4 | 0.32 | 97% | 0.09 |
| 9 | <1 | 25.0% | 272.8 | 818 | 1 | 177.1 | 116.0 | 0.34 | 40% | 0.09 |
| 10 | <1 | 15.6% | 257.2 | 638 | 12 | 174.9 | 115.8 | 0.33 | 47% | 0.09 |
| 11 | <1 | 9.8% | 238.3 | 457 | 17 | 173.9 | 115.9 | 0.34 | 52% | 0.10 |
| 12 | <1 | 4.0% | 237.8 | 155 | 12 | 173.6 | 58.0 | 0.33 | 18% | 0.10 |
| 13 | <1 | 6.4% | 218.9 | 314 | 10 | 173.6 | 115.1 | 3.4 | 56% | 0.98 |

Phosphorus levels of less than 1 ppm were achieved at all temperatures above 237.8° C. and even as low as 218.9° C. when citric acid was present at 3.4 g. Without being bound by theory, the higher the temperature the lower the phosphorous. Additionally, a significant reduction in phosphorous upon increasing residence time from 3 minutes to 11 minutes.

Additionally, three trials were conducted in a similar manner to those above. Trial 1 utilized Crude Soybean oil from a first source, while Trials 2 and 3 utilized a crude degummed soybean oil (CDSBO) acquired from a second source. Reaction conditions were also the same for all three batches: about 238° C. for about 10-12 minutes at a pressure of about 450 psig. About 30% of the water was in the liquid phase, where the remainder was in the headspace of the reactor.

The reactor was quenched following each trial, and the reactor contents were poured into a separatory funnel and permitted to settle for about 2-3 hours at about 77° C. Water separated to the bottom of the separatory funnel and was discarded. Any rag layer was transferred to graduated vials which was also accompanied with several grams of recovered oil. The rag layer was permitted to settle, and the rag and any oil was measured using the vial graduations. The oil remaining in the separatory funnel was dried and weighed. This weight was added to the oil measurement from above the rag in the graduated vials and is recorded below as ‘Recovered Oil.’ Additionally, paper towels with a known starting weight were used to wipe the residual oil from the reactor and agitator; the paper towels were reweighed, and the additional weight was recorded in Table 2 as ‘Reactor Residue’. Data is described below, in reference to Table 2.

TABLE 2

| | Property | | | | | |
|---|---|---|---|---|---|---|
| | Trial 1 | | Trial 2 | | Trial 3 | |
| | First | % of | Second | % of | Second | % of |
| Oil Source | Source | Starting | Source | Starting | Source | Starting |
| Starting Oil | 199.1 | | 202.2 | | 201.1 | |
| (g) | | | | | | |
| Water (g) | 85.5 | | 85.1 | | 84.9 | |
| Citric 50% | 0.6 | | 0.7 | | 0.7 | |
| (g) | | | | | | |
| Initial | 1329 | | 58.8 | | 58.8 | |
| Phosphorous | | | | | | |
| (ppm) | | | | | | |
| Recovered | 189.1 | 95.0% | 198.8 | 98.3% | 194.5 | 96.8% |
| Oil (g) | | | | | | |
| Reactor | 3.7 | 1.9% | 3.3 | 1.7% | 5.2 | 2.6% |
| Residue (g) | | | | | | |
| 70% of | 2.6 | 1.3% | 2.3 | 1.2% | 3.7 | 1.8% |
| Residual (g) | | | | | | |
| Estimated | 6.2 | 3.1% | 1.0 | 0.5% | 0.5 | 0.3% |
| Rag (g) | | | | | | |
| Phosphorous | <1 | | <1 | | <1 | |
| (ppm) | | | | | | |
| Yield | 95.0% | 96.9% | 98.3% | 100% | 96.8% | 99.4% |
| Bounds | | | | | | |
| Estimated | 96.3% | | 99.5% | | 98.6% | |
| Yield | | | | | | |

### Embodiments

Aspects of the present disclosure further relate to any one or more of the following Embodiments E1-E27:
E1. A method of purifying a hydrocarbon, the method including flowing an aqueous phase into a first end of a mixing region of a reactor along a first direction; mixing, via a countercurrent flow, an organic phase with the aqueous phase by flowing the organic phase into a second end opposite to the first end of the mixing region, in which the flow of the organic phase is along a second direction opposite to the first direction, in which the organic phase comprises at least a contaminant; heating the mixing region; extracting a purified organic phase from a purification region of the reactor; and extracting a waste from a waste region of the reactor.
E2. The method of embodiment E1, further including heating the mixing region to a temperature of about 50° C. to about 300° C.
E3. The method of embodiment E1 or E2, further including heating a first region of the mixing region to a first temperature of about 100° C. to about 125° C.; and heating a second region of the mixing region to a second temperature of about 200° C. to about 250° C.
E4. The method of any one of embodiments E1-E3, further including heating the mixing region by introducing a steam.
E5. The method of any one of embodiments E1-E4, further including heating the mixing region using a heat exchanger.
E6. The method of any one of embodiments E1-E5, in which the contaminant comprises one or more organic materials and/or one or more inorganic materials.
E7. The method of embodiment E6, in which the organic material comprises asphaltenes, polymers, high molecular weight organic compounds, waves, coke, coke precursors, nitrogen containing compounds, fatty acids, organic salts, organic soaps, or any combination thereof.
E8. The method of embodiment E6, in which the inorganic material comprises halides, phosphorous, sulfur, alkali metals, metalloids, heavy metals, inorganic salts, inorganic soaps, or any combination thereof.
E9. The method of any one of embodiments E1-E8, in which the mixing region comprises packing material.
E10. The method of any one of embodiments E1-E9, in which mixing the organic phase with the aqueous phase further comprises rotating a displacement component in the mixing region using an actuator, and in which the mixing region comprises an actuator.
E11. The method of any one of embodiments E1-E10, in which mixing the organic phase with the aqueous phase further comprises oscillating a perforated component in the mixing region using an oscillator.
E12. The method of any one of embodiments E1-E11, further including removing a residual aqueous phase from the purified organic phase using a first coalescer.
E13. The method of embodiment E12, further including removing a residual organic phase from the waste using a second coalesce.
E14. A method of purifying a hydrocarbon, the method including flowing an aqueous phase into a first mixing region of a first reactor; mixing an organic phase with the aqueous phase by flowing the organic phase into the first mixing region, separating a purified organic phase from a waste; and directing the purified organic phase from the first reactor to a second mixing region of a second reactor.
E15. The method of embodiment E14, further including flowing the aqueous phase into a first end of the first mixing region along a first direction; and mixing, via a countercurrent flow, the organic phase with the aqueous phase by flowing the organic phase into a second end opposite to the first end of the first mixing region, in which the flow of the organic phase is along a second direction opposite to the first direction,
E16. The method of embodiments E14 or E15, further including heating the first mixing region to a temperature of about 50° C. to about 300° C.
E17. The method of any one of embodiments E14-E16, further including heating the first mixing region by introducing a steam.
E18. The method of any one of embodiments E14-E17, in which mixing the organic phase with the aqueous phase further includes rotating a displacement component in the first mixing region using an actuator.
E19. A method of purifying a hydrocarbon, the method including flowing an aqueous phase including water into a first end of a mixing region of a reactor along a first direction; mixing, via a countercurrent flow, an organic phase with the aqueous phase by flowing the organic phase into a second end opposite to the first end of the mixing region, in which the organic phase comprises an oil, fat, grease, or combination thereof, in which the flow of the organic phase is along a second direction opposite to the first direction, and in which the organic phase comprises one or more contaminants including halides, phosphorous, sulfur, alkali metals, metalloids, heavy metals, or any combination thereof; heating the mixing region; extracting a purified organic phase from a purification region of the reactor; and directing the waste to a recuperator.
E20. The method of embodiment E19, further including heating the mixing region.
E21. The method of embodiments E19 or E20, further including producing a mixture to be introduced to the reactor by mixing the organic phase with the waste of the recuperator.
E22. The method of embodiment E21, further including cooling the mixture using a cooling unit.
E23. The method of embodiment E22, further including introducing the cooled mixture to the reactor.
E24. The method of any one of embodiments E19-E23, further including heating a region of the mixing region using an external heat exchanger.
E25. The method of embodiment E24, further including: extracting a portion of a volume in the mixing region; directing the portion of the volume to an external vessel; heating the external vessel using the external heat exchanger; and directing the portion of the volume in the external vessel to the mixing region of the reactor, in which transferring the portion of the volume includes cooling the portion of the volume using a cooling system.
E26. The method of any one of embodiments E19-E25, in which the organic phase includes a dispersed phase and the aqueous phase includes a continuous phase.
E27. The method of any one of embodiments E19-E26, in which the organic phase includes a continuous phase and the aqueous phase includes a dispersed phase.
E28. The method of any one of embodiments E19-E27, in which the aqueous phase includes an additive, in which the additive is a hydrolyzing agent.

Overall, systems and methods of the present disclosure provide a hydrocarbon purification method that utilizes countercurrent liquid-liquid extraction to increase mixing between the aqueous phase and the organic phase, which increases the purity of the purified hydrocarbon without the requirement to produce glycerol and reduces the total amount of water utilized in the purification process, reducing operating costs. By implementing countercurrent fluid flow, a reduction and/or elimination of a centrifugation requirement occurs as the contaminants are removed from oil during countercurrent fluid flow. Moreover, the aqueous phase and the organic phase may be introduced to at least one reactor, where the aqueous phase and the organic phase are subject to a temperature profile, increasing the extraction of the contaminants in the organic phase. The hydrocarbon purification method may reduce capital expenses and operating expenses as the system requires less storage tanks and/or reactors than conventional hydrocarbon purification systems. Additionally, the aqueous phase may be reintroduced to the reactor via a recycler that further reduces operating expenses, as compared to conventional hydrocarbon purification systems.

While the foregoing is directed to embodiments of the disclosure, other and further embodiments may be devised without departing from the basic scope thereof, and the scope thereof is determined by the claims that follow. All documents described herein are incorporated by reference herein, including any priority documents and/or testing procedures to the extent they are not inconsistent with this text. As is apparent from the foregoing general description and the specific embodiments, while forms of the present disclosure have been illustrated and described, various modifications can be made without departing from the spirit and scope of the present disclosure. Accordingly, it is not intended that the present disclosure be limited thereby. Likewise, the term “comprising” is considered synonymous with the term “including” for purposes of United States law. Likewise, whenever a composition, an element, or a group of elements is preceded with the transitional phrase “comprising”, it is understood that the same composition or group of elements with transitional phrases “consisting essentially of”, “consisting of”, “selected from the group of consisting of”, or “is” preceding the recitation of the composition, element, or elements and vice versa, are contemplated. As used herein, the term “about” refers to a +/−10% variation from the nominal value. It is to be understood that such a variation can be included in any value provided herein.

Certain embodiments and features have been described using a set of numerical upper limits and a set of numerical lower limits. It should be appreciated that ranges including the combination of any two values, e.g., the combination of any lower value with any upper value, the combination of any two lower values, and/or the combination of any two upper values are contemplated unless otherwise indicated. Certain lower limits, upper limits and ranges appear in one or more claims below.

1. A method of purifying a hydrocarbon, the method comprising:
flowing an aqueous phase into a first end of a mixing region of a reactor along a first direction;
mixing, via a countercurrent flow, an organic phase with the aqueous phase by flowing the organic phase into a second end opposite to the first end of the mixing region, wherein the flow of the organic phase is along a second direction opposite to the first direction, wherein the organic phase comprises at least a contaminant;
heating the mixing region;
extracting a purified organic phase from a purification region of the reactor; and
extracting a waste from a waste region of the reactor.

2. The method of claim 1, further comprising heating the mixing region to a temperature of about 50° C. to about 300° C.

3. The method of claim 1, further comprising:
heating a first region of the mixing region to a first temperature of about 100° C. to about 125° C.; and
heating a second region of the mixing region to a second temperature of about 200° C. to about 250° C.

4. The method of claim 1, further comprising heating the mixing region by introducing a steam.

5. The method of claim 1, further comprising heating the mixing region using a heat exchanger.

6. The method of claim 1, wherein the contaminant comprises an organic material or an inorganic material.

7. The method of claim 6, wherein the organic material comprises asphaltenes, polymers, high molecular weight organic compounds, waves, coke, coke precursors, nitrogen containing compounds, fatty acids, organic salts, organic soaps, or any combination thereof.

8. The method of claim 6, wherein the inorganic material comprises halides, phosphorous, sulfur, alkali metals, metalloids, heavy metals, inorganic salts, inorganic soaps, or any combination thereof.

9. The method of claim 1, wherein the mixing region comprises packing material.

10. The method of claim 1, wherein mixing the organic phase with the aqueous phase further comprises rotating a displacement component in the mixing region using an actuator, and wherein the mixing region comprises an actuator.

11. The method of claim 1, wherein mixing the organic phase with the aqueous phase further comprises oscillating a perforated component in the mixing region using an oscillator.

12. The method of claim 1, further comprising removing a residual aqueous phase from the purified organic phase using a first coalescer.

13. The method of claim 12, further comprising removing a residual organic phase from the waste using a second coalescer.

14. A method of purifying a hydrocarbon, the method comprising:
flowing an aqueous phase into a first mixing region of a first reactor;
mixing an organic phase with the aqueous phase by flowing the organic phase into the first mixing region;
separating a purified organic phase from a waste; and
directing the purified organic phase from the first reactor to a second mixing region of a second reactor.

15. The method of claim 12, further comprising flowing the aqueous phase into a first end of the first mixing region along a first direction; and
mixing, via a countercurrent flow, the organic phase with the aqueous phase by flowing the organic phase into a second end opposite to the first end of the first mixing region, wherein the flow of the organic phase is along a second direction opposite to the first direction.

16. The method of claim 14, further comprising heating the first mixing region to a temperature of about 50° C. to about 300° C.

17. The method of claim 14, further comprising heating the first mixing region by introducing a steam.

18. The method of claim 14, wherein mixing the organic phase with the aqueous phase further comprises rotating a displacement component in the first mixing region using an actuator.

19. A method of purifying a hydrocarbon, the method comprising:
flowing an aqueous phase comprising water into a first end of a mixing region of a reactor along a first direction;
mixing, via a countercurrent flow, an organic phase with the aqueous phase by flowing the organic phase into a second end opposite to the first end of the mixing region, wherein the organic phase comprises an oil, fat, grease, or combination thereof, wherein the flow of the organic phase is along a second direction opposite to the first direction, and wherein the organic phase comprises at least a contaminant comprising halides, phosphorous, sulfur, alkali metals, metalloids, heavy metals, or any combination thereof;
heating the mixing region;
extracting a purified organic phase from a purification region of the reactor;
extracting a waste from a waste region of the reactor; and
directing the waste to a recuperator.

20. The method of claim 19, further comprising heating the mixing region.

21. The method of claim 19, further comprising producing a mixture to be introduced to the reactor by mixing the organic phase with the waste of the recuperator.

22. The method of claim 21, further comprising producing a cooled mixture by cooling the mixture using a cooling unit.

23. The method of claim 22, further comprising introducing the cooled mixture to the reactor.

24. The method of claim 19, further comprising heating a first region of the mixing region using an external heat exchanger.

25. The method of claim 24, further comprising:
extracting a portion of a volume in the mixing region;
directing the portion of the volume to an external vessel;
heating the external vessel using the external heat exchanger; and
directing the portion of the volume in the external vessel to the mixing region of the reactor, wherein transferring the portion of the volume includes cooling the portion of the volume using a cooling system.

26. The method of claim 19, wherein the organic phase comprises a dispersed phase and the aqueous phase comprises a continuous phase.

27. The method of claim 19, wherein the organic phase comprises a continuous phase and the aqueous phase comprises a dispersed phase.

28. The method of claim 19, wherein the aqueous phase comprises an additive, wherein the additive is a hydrolyzing agent.
